(19) United States
(12) Patent Application Publication
(10) Pub. No.: US 2020/0324669 A1
(43) Pub. Date: Oct. 15, 2020

(54) VEHICLE SEAT CONTROL DEVICE

(71) Applicant: DENSO CORPORATION, Kariya-city, Aichi-pref. (JP)

(72) Inventor: Masaki AMAKAWA, Kariya-city (JP)

(73) Assignee: DENSO CORPORATION, Kariya-city, Aichi-pref. (JP)

(21) Appl. No.: 16/759,923

(22) PCT Filed: Dec. 11, 2018
(86) PCT No.: PCT/JP2018/045569

§ 371 Date: Apr. 28, 2020

(30) Foreign Application Priority Data
Dec. 21, 2017 (JP) 2017-245268

(51) Int. Cl. B60N 2/02; B60N 2/24; B60N 2/04; B60N 2/90

(52) U.S. Cl. CPC B60N 2/0224; B60N 2/90; B60N 2/04; B60N 2/24

(57) ABSTRACT

A vehicle seat control device is mounted on a vehicle that is switchable between autonomous driving and manual driving, and the vehicle control device controls a state of a vehicle seat. The vehicle seat control device includes a seat state changer, a load detector, and a controller. The seat state changer changes the state of the vehicle seat. The load detector detects a load applied to the vehicle seat. The controller controls the seat state changer in accordance with the load detected by the load detector. The controller is configured to limit a state change of the vehicle seat caused by the seat state changer during the manual driving more than a state change of the vehicle seat caused by the seat state changer during the autonomous driving.

### CROSS-REFERENCE TO RELATED APPLICATION

The present application claims priority from Japanese Patent Application No. 2017-245268 filed on Dec. 21, 2017, the entire contents of which are incorporated by reference herein.

### TECHNICAL FIELD

The present disclosure relates to a vehicle seat control device.

### BACKGROUND ART

Conventionally, a vehicle seat control device (for example, refer to Patent Document 1) changes the state (arrangement) of a vehicle seat based on load information of an occupant obtained from load sensors arranged at various locations on the vehicle seat.

Such a vehicle seat control device includes a mode switch configured to switch between a fixed mode and an operational mode. The mode switch prohibits arrangement changes of the vehicle seat in the fixed mode and allows arrangement changes of the vehicle seat in the operational mode.

### PRIOR ART DOCUMENT

### Patent Document

Patent Document 1: Japanese Laid-Open Patent Publication No. 2008-195323

### SUMMARY OF THE INVENTION

The development of autonomous driving technology for vehicles has been advancing in recent years in the field of automobiles. Accordingly, in the above vehicle seat control device, comfort is required for autonomous driving while safety is required for manual driving. Thus, if the same movement is performed for autonomous driving and manual driving, one of the requirements will not be satisfied.

One objective of the present disclosure is to provide a vehicle seat control device that achieves both of comfort for autonomous driving and safety for manual driving.

A vehicle seat control device in accordance with one embodiment of the present disclosure is mounted on a vehicle that is switchable between autonomous driving and manual driving, and the vehicle control device controls a state of a vehicle seat. The vehicle seat control device includes a seat state changer, a load detector, and a controller. The seat state changer changes the state of the vehicle seat. The load detector detects a load applied to the vehicle seat. The controller controls the seat state changer in accordance with the load detected by the load detector. The controller is configured to limit a state change of the vehicle seat caused by the seat state changer during the manual driving more than a state change of the vehicle seat caused by the seat state changer during the autonomous driving.

The above embodiment limits the state change of the vehicle seat caused by the seat state changer more during the manual driving than during the autonomous driving. This ensures safety when adjusting a position of the vehicle seat during the manual driving. Further, the state change of the vehicle seat caused by the seat state changer during the autonomous driving is not as (less) limited compared to during the manual driving. This ensures comfort when adjusting the position of the seat during the autonomous driving.

### BRIEF DESCRIPTION OF THE DRAWINGS

FIG. 1 is a schematic diagram showing a vehicle seat of one embodiment.

FIG. 2 is a control block diagram of a vehicle seat control device.

FIG. 3 is a flowchart illustrating a control example of the vehicle seat control device of FIG. 2.

FIG. 4 is a flowchart illustrating a control example of a vehicle seat control device of a modified example.

### MODE FOR CARRYING OUT THE INVENTION

One embodiment of a vehicle seat including a vehicle seat control device will now be described.

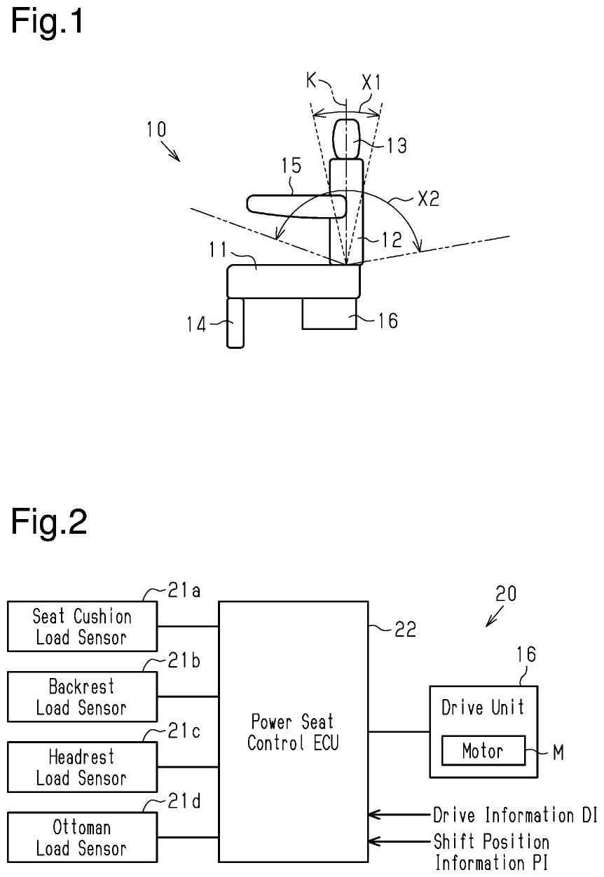

As shown in FIG. 1, a vehicle seat 10 of the present embodiment includes a seat cushion 11, a backrest 12, a headrest 13, an ottoman 14, and two armrests 15. The seat cushion 11 is configured so that an occupant can be seated, the backrest 12 is configured to support the back of the occupant, the headrest 13 is configured to support the head of the occupant, the ottoman 14 is configured to support the legs of the occupant, and the armrests 15 are configured to support the arms of the occupant. The vehicle seat 10 of the present example includes frames (not shown) inside the seat cushion 11, the backrest 12, the headrest 13, the ottoman 14, and the armrests 15. The frames maintain, for example, the form of the vehicle seat 10.

The backrest 12 is arranged at a rear of the seat cushion 11 in an inclinable manner. Further, the headrest 13 is arranged on the end of the backrest 12 at the opposite side of the seat cushion 11 (upper part in FIG. 1). The ottoman 14 is arranged at the front of the seat cushion 11 in an inclinable manner.

As shown in FIG. 1, the two armrests 15 extend forward from left and right sides of the backrest 12, respectively.

Further, the vehicle seat 10 includes a drive unit (seat state changer) 16. The drive unit 16 changes arrangement (state) of the vehicle seat 10 when a motor M is driven in response to a control signal from a vehicle seat control device 20. Examples of changes to the arrangement or position of the vehicle seat 10 include changes in a vertical position or a front-and-rear position of the vehicle seat 10, an inclination angle of the backrest 12, an inclination angle of the ottoman 14, and an inclination angle of the front end of the seat cushion 11. These are simply examples and other changes in position are possible.

As shown in FIG. 2, the vehicle seat control device 20 includes a plurality of load sensors (load detector) 21a to 21d and a power seat control ECU (controller) 22. The power seat control ECU 22 controls the drive unit 16 in accordance with detection results of the load sensors 21a to 21d.

The load sensors 21a to 21d include a seat cushion load sensor 21a, a backrest load sensor 21b, a headrest load sensor 21c, and an ottoman load sensor 21d. The seat cushion load sensor 21a is arranged on the seat cushion 11 and detects a load applied to the seat cushion 11. The backrest load sensor 21b is arranged on the backrest 12 and detects a load applied to the backrest 12. The headrest load sensor 21c is arranged on the headrest 13 and detects a load applied to the headrest. The ottoman load sensor 21d is arranged on the ottoman 14 and detects a load applied to the ottoman 14. The load sensors 21a to 21d may each be, for example, a sensor such as a strain gauge. The load sensors 21a to 21d each output the detection result to the power seat control ECU 22.

The power seat control ECU 22 calculates changes in the load added to each part of the vehicle seat 10 from the detection results of the load sensors 21a to 21d and controls the drive unit 16 in accordance with the calculated load changes.

Further, the power seat control ECU 22 receives driving information DI and shift position information PI as external signals. The driving information DI indicates whether the vehicle is currently in an autonomous driving mode or a manual driving mode. The shift position information PI indicates the present position of a shift lever. Here, the driving information DI is for recognizing whether an occupant has selected the autonomous driving mode or the manual driving mode, for example, from an operation of a mode switch (not shown). Thus, the driving information DI of the present example does not include information on whether the vehicle is actually moving or is likely to move. The shift position information PI indicates the present position information of the shift lever detected by, for example, a gear position sensor (not shown).

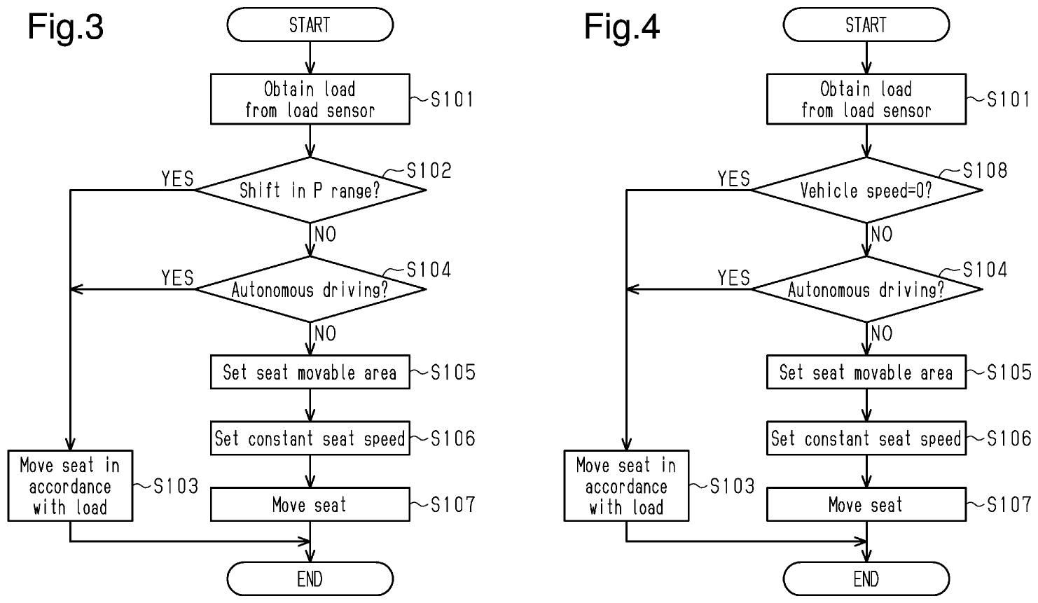

An example of movement of the vehicle seat 10 including the vehicle seat control device 20 will now be described with reference to FIG. 3. The movement example described below is an inclination movement (reclining movement) of the backrest 12 of the vehicle seat 10, and similar control (movement) is applicable to other changes.

As shown in FIG. 3, the power seat control ECU 22 obtains load information from the backrest load sensor 21b (step S101).

Then, the power seat control ECU 22 obtains the shift position information PI and determines with the shift position information PI whether the present position of the shift lever is in “P” range (step S102).

When the present position of the shift lever is in the P range (step S102: YES), the power seat control ECU 22 controls the motor M in accordance with the load obtained with the load sensor (backrest load sensor 21b) and drives the drive unit 16 (step S103). In this case, a movable area (movable amount) or a moving speed of the vehicle seat 10 resulting from the drive unit 16 are not particularly restricted.

When the present position of the shift lever is not in P range (step S102: NO), the power seat control ECU 22 determines whether the vehicle is in the autonomous driving mode or the manual driving mode from the driving information DI (step S104).

When the autonomous driving mode is determined from the driving information DI (step S104: YES), the power seat control ECU 22 executes step S103. In this case, the movable area (movable amount) and the moving speed of the vehicle seat 10 resulting from the drive unit 16 are not particularly restricted. The vehicle is in a state in which, for example, the movable area (movable amount) is larger and the moving speed is higher than in the manual driving mode, which will be described below.

When the manual driving mode is determined from the driving information DI (step S104: NO), the power seat control ECU 22 sets the movable area (movable amount) of the vehicle seat 10 using the present position of the vehicle seat 10 as a reference (step S105). In this case, the movable area (movable amount) is more limited than the movable area (movable amount) set in step S103. Specifically, as shown in FIG. 1, the reclining movement of the backrest 12 is set to a limited movable area X1 using to the present position K as the reference. The limited movable area X1 is a range smaller than the movable area described in step S103 (range indicated by X2 in FIG. 1).

Next, the power seat control ECU 22 sets the moving speed of the vehicle seat 10 to be constant (step S106), controls the motor M in accordance with the load obtained with the load sensor (backrest load sensor 21b), and drives the drive unit 16 (step S107).

The operation of the present embodiment will now be described.

The vehicle seat control device 20 of the present embodiment changes the state (arrangement) of the vehicle seat 10 by controlling the drive unit 16 in accordance with the load (load change) obtained from the load sensors 21a to 21d. In this case, the power seat control ECU 22, for example, controls the drive unit 16 so that the state change of the vehicle seat 10 is more limited in the manual driving mode than in the autonomous driving mode.

The present embodiment has the following advantages.

(1) The state change of the vehicle seat 10 resulting from the drive unit 16 is more limited during manual driving than during autonomous driving. This ensures safety when adjusting the position of the vehicle seat 10 during manual driving. Also, the state change of the vehicle seat 10 resulting from the drive unit 16 is not as (less) limited during autonomous driving compared to manual driving. This ensures comfort when adjusting the position of the vehicle seat 10 during autonomous driving.

(2) The moving speed of the vehicle seat 10 is lower during manual driving than during autonomous driving. This ensures safety when adjusting the position of the vehicle seat 10 during manual driving.

(3) The moving speed of the vehicle seat 10 when changing the state of the vehicle seat 10 during manual driving is constant. This ensures safety when adjusting the position of the vehicle seat 10 during manual driving in comparison with a case where the moving speed changes.

(4) The movable amount (movable area) from the present position of the vehicle seat 10 is smaller during manual driving than during autonomous driving. This ensures safety when adjusting the position of the vehicle seat 10 during manual driving.

(5) The power seat control ECU 22 controls the drive unit 16 in accordance with the number of pulse edges of the motor M. This allows for fine adjustment of the state of the vehicle seat 10. As a result, the vehicle seat 10 is readily adjusted to a state intended by an occupant even during manual driving.

The above-described embodiment may be modified as follows.

In the above embodiment, the determination of whether the position of the shift lever is in the P range is executed in accordance with the shift position information PI after step S101 (step S102 in FIG. 3). However, there is no limit to such a configuration.

As shown in FIG. 4, the control configuration may include a process for determining whether a vehicle speed is zero, for example, after step S101 (step S108). The determination of whether the vehicle speed is zero indicates whether the vehicle is actually moving (driving). When adjusting the state of the vehicle seat 10, if the vehicle speed is zero, the vehicle seat is moved in accordance with the load without any specific restrictions to maintain comfort.

In the above embodiment, the moving speed of the state change of the vehicle seat 10 during manual driving is set to be substantially constant. However, the moving speed may be changed.

Although not specifically described in the above embodiment, the moving speed of state change of the vehicle seat 10 during autonomous driving may be substantially constant.

In the above embodiment, the movable area X1 from the present position K of the vehicle seat 10 during manual driving is narrower (smaller) than the movable area X2 during autonomous driving, and the moving speed of the vehicle seat 10 is lower during manual driving than during autonomous driving. However, there is no limit to such a configuration. For example, the movable area X1 and the movable area X2 may be substantially the same, and only the moving speed may be different. Alternatively, the moving speed may be the same during manual driving and autonomous driving, and the movable area X1 and the movable area X2 may be different.

In the above embodiment, the limitation (of movable area or moving speed) when changing the state of the vehicle seat 10 is adjusted by controlling the motor M. Alternatively, a structure other than the motor M may be controlled to adjust the limitation when changing the state of the vehicle seat 10. For example, a method may be employed in which a mechanical portion of the drive unit 16 is changed to vary the movable area of the vehicle seat 10.

Alternatively, a threshold value used in a determination based on the information detected by the load sensors 21a to 21d may differ between autonomous driving and manual driving. The threshold value may be used as a limitation when changing the state of the vehicle seat 10 as described above. That is, the state change of the vehicle seat 10 may be more moderate for a determination based on the load sensors 21a to 21d during manual driving than a determination based on the load sensors 21a to 21d during autonomous driving.

In the above embodiment, the drive unit 16 is controlled in accordance with the number of pulse edges of the motor M. However, the embodiment is not limited to such a configuration. For example, the state of each part of the vehicle seat 10 may be directly detected by, for example, a gyro sensor or the like and the drive unit 16 may be controlled in accordance with the detection result.

In the configuration of the above embodiment, the ottoman 14 is part of the vehicle seat 10. However, the ottoman 14 may be omitted. In this case, the ottoman load sensor 21d, which is arranged on the ottoman 14, is also omitted.

In the configuration of the above embodiment, the armrests 15 are part of the vehicle seat 10. However, the armrests 15 may be omitted.

The described embodiment and the above modifications may be combined in any suitable manner.

The power seat control ECU 22 may be configured, for example, by circuitry, that is, at least one exclusive hardware circuit such as an application-specific integrated circuit (ASIC), at least one processing circuit that runs on a computer program (software), or a combination of the above. The processing circuit includes a CPU and memories (ROM, RAM, and the like), which store programs executed by the CPU. The memory, which is a computer readable medium, may be any available medium that is accessible by a versatile or dedicated computer.

1. A vehicle seat control device mounted on a vehicle that is switchable between autonomous driving and manual driving, wherein the vehicle control device controls a state of a vehicle seat, the vehicle seat control device comprising:
a seat state changer that changes the state of the vehicle seat;
a load detector that detects a load applied to the vehicle seat; and
a controller that controls the seat state changer in accordance with the load detected by the load detector,
wherein the controller is configured to limit a state change of the vehicle seat caused by the seat state changer during the manual driving more than a state change of the vehicle seat caused by the seat state changer during the autonomous driving.

2. The vehicle seat control device according to claim 1, wherein the controller is configured to set a slower moving speed of the state change of the vehicle seat caused by the seat state changer during the manual driving than a moving speed of the state change of the vehicle seat during the autonomous driving.

3. The vehicle seat control device according to claim 1, wherein the controller is configured to control the seat state changer so that the moving speed of the state change of the vehicle seat during the manual driving is constant.

4. The vehicle seat control device according to claim 1, wherein the controller is configured to limit the state change of the vehicle seat so that a movable amount of the vehicle seat from a present position is smaller during the manual driving than during the autonomous driving.

5. The vehicle seat control device according to claim 1, wherein
the seat state changer changes the state of the vehicle seat by driving a motor, and
the controller is configured to control the seat state changer in accordance with a number of pulse edges of the motor.
